(19) United States
(12) Patent Application Publication
(10) Pub. No.: US 2005/0168873 A1
(43) Pub. Date: Aug. 4, 2005

(54) Magnetic head substrate material, magnetic head substrate, head slider, and method of making magnetic head substrate

(75) Inventors: Yukio Kawaguchi, Tokyo (JP); Cheng Yih Liu, Kwai Chung (HK)

Correspondence Address: OLIFF & BERRIDGE, PLC, P.O. BOX 19928, ALEXANDRIA, VA, 22320, US

(73) Assignees: TDK CORPORATION, Tokyo (JP); SAE MAGNETICS (H.K.) LTD., Hong Kong (CN)

(21) Appl. No.: 11/013,742

(22) Filed: Dec. 17, 2004

(30) Foreign Application Priority Data
Dec. 22, 2003 (JP) P2003-425622

(51) Int. Cl. G11B 5/60

(52) U.S. Cl. 360/235.1

(57) ABSTRACT

A magnetic head substrate used in a head slider includes any of a sintered body, substantially free of Al₂O₃, containing TiCN; a sintered body, substantially free of Al₂O₃, containing TiCON; a sintered body containing TiCN and 10 wt % or less of Al₂O₃; and a sintered body containing TiCON and 10 wt % or less of Al₂O₃. The head slider has a structure in which a thin-film magnetic head is laminated on a support formed from the magnetic head substrate.

### BACKGROUND OF THE INVENTION

1. Field of the Invention

The present invention relates to a magnetic head substrate material, a magnetic head substrate, a head slider, and a method of making a magnetic head substrate.

2. Related Background Art

A head slider formed with a thin-film magnetic head was employed in a hard disk drive for the first time in 1979. The head slider at that time has been referred to as mini slider (100% slider) in general. Thereafter, by way of micro slider (70% slider) whose size is about 70% that of the mini slider, head sliders have been reducing their size to become nano slider (50% slider) whose size is about 50% that of the mini slider.

These sliders have been required to satisfy a CSS (Contact Start and Stop) property. Namely, since their air bearing surface (ABS) opposing a recording surface of a recording medium and the recording medium repeatedly come into contact with each other upon recording and/or reproducing, a sufficient durability has been required for them. Therefore, a material having a high hardness mainly composed of aluminum oxide (Al₂O₃) and titanium carbide (TiC) has been employed so as to form a magnetic head substrate (hereinafter abbreviated as substrate) in conventional head sliders as disclosed in Japanese Patent Application Laid-Open No. SHO 57-82172, for example.

### SUMMARY OF THE INVENTION

Currently, however, head sliders known as pico slider (30% slider) whose size is about 30% that of the mini slider have become mainstream. From now on, as hard disk drives reduce their size and lower their cost, head sliders are expected to further reduce their size and shift to femto slider (20% slider) whose size is about 20% that of the mini slider.

As the head sliders reduce their size, properties required for them have been changing from conventional ones. In head sliders having reduced their size such as femto sliders, their contact area with the recording medium becomes smaller than that in nano sliders, whereby the CSS property is less important than improvements in surface smoothness when the substrate is subjected to ion milling, reactive ion etching (RIE), and the like (collectively referred to as “etching”) and reductions in the difference in height of the air bearing surface caused by the amount of shaving in the substrate and a thin-film laminate on the substrate in a lapping step for forming the air bearing surface.

In view of the problems of the prior art mentioned above, it is an object of the present invention to provide a magnetic head substrate material, a magnetic head substrate, a head slider, and a method of making a magnetic head substrate, which can improve the surface smoothness of the etching surface and lower the difference in height of the air bearing surface.

The etching surface of the magnetic head substrate lowers its surface smoothness because of irregularities on the surface. The inventors started studies about the present invention by finding a cause of irregularities on the etching surface of the magnetic head substrate and trying to eliminate the cause. Then, the inventors conducted diligent studies in order to improve the surface smoothness of the etching surface and reduce the difference in height of the air bearing surface and, as a result, have found that the above-mentioned object is achieved when TiCN or TiCON is contained in the magnetic head substrate, thereby achieving the present invention. In the following, “substantially free of Al₂O₃” means to exclude the case where Al₂O₃ is positively contained by intention, whereby an unintentionally contained minute amount of Al₂O₃, such as about 1.0 wt % of Al₂O₃ mingling in the manufacturing process does not count as “Al₂O₃” here.

In one aspect, the present invention provides a magnetic head substrate material comprising a nonmagnetic material, substantially free of Al₂O₃, containing TiCN.

Since a nonmagnetic material containing TiCN is employed as a magnetic head substrate material in this aspect of the present invention, the magnetic head substrate obtained by sintering the nonmagnetic material exhibits a hardness lower than that obtained when a magnetic head substrate material containing TiC is used as in conventional head sliders. Therefore, the amount of shaving of the magnetic head substrate can be made on a par with that of the thin-film laminate on the magnetic head substrate in a lapping step for forming an air bearing surface, whereby the air bearing surface can be made substantially flat.

It has been considered favorable in general for the conventional magnetic head substrates to be made by 60 wt % of Al₂O₃ and 40 wt % of TiC. However, thus made substrates have failed to yield a single-phase structure, whereby particles of constituent materials float up to the etching surface, thereby yielding irregularities, which lower the surface smoothness. In the magnetic head substrate made by using the magnetic head substrate material in accordance with this aspect of the present invention, substantially a single phase of TiCN is formed, so that irregularities on the etching surface are reduced, whereby the surface smoothness of the etching surface is improved.

In another aspect, the present invention provides a magnetic head substrate material comprising a nonmagnetic material, substantially free of Al₂O₃, containing TiCN and TiO₂.

Since TiO₂ is contained together with TiCN, TiO₂ functions as a sintering additive, thereby improving the sintering property. The magnetic head substrate obtained after sintering is constituted by a sintered body containing TiCON, and thus yields a hardness lower than that obtained in the case using a magnetic head substrate material containing TiC, whereby the air bearing surface can be made substantially flat because of the reason mentioned above. The magnetic head substrate obtained by sintering is constituted by a sintered body made of substantially a single phase of TiCON, so that irregularities on the etching surface generated by particles of constituent materials floating up are reduced, whereby the surface smoothness of the etching surface improves.

Preferably, in this case, the content of TiO₂ in the nonmagnetic material is 30 wt % or less. This can lower the amount of TiO₂ particles left without combining with TiCN in the magnetic head substrate obtained by sintering, so as to reduce irregularities on the etching surface, whereby the surface smoothness of the etching surface can become better.

In still another aspect, the present invention provides a magnetic head substrate comprising a sintered body, substantially free of Al₂O₃, containing TiCN.

The magnetic head substrate in accordance with this aspect of the present invention is constituted by a sintered body containing TiCN and thus yields a hardness lower than that of a magnetic head substrate constituted by a sintered body containing TiC. Therefore, the amount of shaving of the magnetic head substrate can be made on a par with that of the thin-film laminate on the magnetic head substrate in a lapping step for forming an air bearing surface, whereby the air bearing surface can be made substantially flat. In the magnetic head substrate in accordance with this aspect of the present invention, substantially a single phase of TiCN is formed, so that irregularities on the etching surface are reduced, whereby the surface smoothness of the etching surface is improved.

In this case, it will be preferred that x/(x+y) is at least 50% but not greater than 90%, where the molar composition of TiCN is expressed as TiC_{y}Nₓ. This allows the surface smoothness of the etching surface and the air bearing surface to attain more optimal states.

In still another aspect, the present invention provides a magnetic head substrate comprising a sintered body, substantially free of Al₂O₃, containing TiCON.

The magnetic head substrate in accordance with this aspect of the present invention is constituted by a sintered body containing TiCON and thus yields a hardness lower than that of a magnetic head substrate constituted by a sintered body containing TiC, whereby the air bearing surface can be made substantially flat because of the reason mentioned above. Further, since the substrate is constituted by substantially a single phase of TiCON, irregularities on the etching surface generated by particles of constituent materials floating up are reduced, whereby the surface smoothness of the etching surface improves.

In this case, it will be preferred that x/(x+y+z) is at least 50% but not greater than 90%, where the molar composition of TiCON is expressed as TiC_{y}O_{z}Nₓ. This allows the surface smoothness of the etching surface and the air bearing surface to attain more optimal states.

Preferably, the sintered body contains TiO₂ by a content of 30 wt % or less. This allows the etching surface in the magnetic head substrate to have a better surface smoothness.

In still another aspect, the present invention provides a magnetic head substrate comprising a sintered body containing TiCN and Al₂O₃, wherein the content of Al₂O₃ is 10 wt % or less.

The magnetic head substrate in accordance with this aspect of the present invention is constituted by a sintered body containing TiCN and thus yields a hardness lower than that obtained by the magnetic head substrate constituted by a sintered body containing TiC, thereby allowing the air bearing surface to attain a favorable state with its difference in height being lowered. Also, since the content of Al₂O₃ is 10 wt % or less, the magnetic head substrate is constituted by a sintered body made of substantially a single phase of TiN, so that irregularities on the etching surface are lowered, whereby the surface smoothness of the etching surface improves.

In still another aspect, the present invention provides a magnetic head substrate comprising a sintered body containing TiCON and Al₂O₃, wherein the content of Al₂O₃ is 10 wt % or less.

The magnetic head substrate in accordance with this aspect of the present invention is constituted by a sintered body containing TiCON and thus yields a hardness lower than that obtained by the magnetic head substrate constituted by a sintered body containing TiC, thereby allowing the air bearing surface to attain a favorable state with its difference in height being lowered. Also, since the content of Al₂O₃ is 10 wt % or less, the magnetic head substrate is constituted by a sintered body made of substantially a single phase of TiCON, so that irregularities on the etching surface are lowered, whereby the surface smoothness of the etching surface improves.

Preferably, the content of Al₂O₃ is at least 2 wt %. In this case, the magnetic head substrate is constituted by a material having a substantially completely single phase mainly composed of TiCN or TiCON, whereby the surface smoothness of the etching surface further improves.

In still another aspect, the present invention provides a head slider comprising a support constituted by a sintered body, substantially free of Al₂O₃, containing TiCN; and a thin-film magnetic head, formed on the support, for recording and/or reproducing with respect to a recording medium.

In still another aspect, the present invention provides a head slider comprising a support constituted by a sintered body, substantially free of Al₂O₃, containing TiCON; and a thin-film magnetic head, formed on the support, for recording and/or reproducing with respect to a recording medium.

The head slider in accordance with such an aspect of the present invention allows the etching surface to improve its surface smoothness and the air bearing surface to attain substantially a flat state with its difference in height being lowered as compared with the case using a support constituted by a sintered body containing TiC.

Preferably, in this case, the sintered body contains TiO₂ by a content of 30 wt % or less. This can yield a better sintering property, whereby the sintered body can be prevented from peeling.

In still another aspect, the present invention provides a head slider comprising a support constituted by a sintered body containing TiCN and Al₂O₃, the content of Al₂O₃ being 10 wt % or less; and a thin-film magnetic head, formed on the support, for recording and/or reproducing with respect to a recording medium.

In still another aspect, the present invention provides a head slider comprising a support constituted by a sintered body containing TiCON and Al₂O₃, the content of Al₂O₃ being 10 wt % or less; and a thin-film magnetic head, formed on the support, for recording and/or reproducing with respect to a recording medium.

The head slider in accordance with such an aspect of the present invention allows the etching surface to improve its surface smoothness and the air bearing surface to attain substantially a flat state with its difference in height being lowered as compared with the case using a support constituted by a sintered body containing TiC.

Preferably, the content of Al₂O₃ is at least 2 wt %. In this case, the head slider is constituted by a material having a substantially completely single phase mainly composed of TiCN or TiCON, whereby the surface smoothness of the etching surface further improves.

In still another aspect, the present invention provides a method of making a magnetic head substrate, the method comprising the steps of preparing a nonmagnetic material, substantially free of Al₂O₃, containing TiCN; and sintering the nonmagnetic material.

The present invention can yield a magnetic head substrate having a hardness lower than that of a magnetic head substrate formed from a magnetic head substrate material containing TiC like a conventional head slider. As a consequence, the amount of shaving of the substrate can be made on a par with that of the thin-film laminate on the substrate in a lapping step for forming an air bearing surface, whereby the air bearing surface can be made substantially flat. Also, the method in accordance with this aspect of the present invention can yield a magnetic head substrate constituted by substantially a single phase of TiCN, so that irregularities on the etching surface generated by particles of constituent materials floating up are reduced, whereby the surface smoothness of the etching surface can be improved.

In still another aspect, the present invention provides a method of making a magnetic head substrate, the method comprising the steps of preparing a nonmagnetic material, substantially free of Al₂O₃, containing TiCN and TiO₂; and sintering the nonmagnetic material.

Since TiO₂ is contained together with TiCN in this aspect of the present invention, TiO₂ functions as a sintering additive, whereby the sintering property can be improved. Also, the magnetic head substrate obtained by the method in accordance with this aspect of the present invention is constituted by a sintered body containing TiCON and thus yields a hardness lower than that obtained in the case using a magnetic head substrate material containing TiC. As a consequence, the amount of shaving of the substrate can be made on a par with that of the thin-film laminate on the substrate in a lapping step for forming an air bearing surface, whereby the air bearing surface can be made substantially flat. Also, the method in accordance with this aspect of the present invention can yield a magnetic head substrate constituted by substantially a single phase of TiCON, so that irregularities on the etching surface generated by particles of constituent materials floating up are reduced, whereby the surface smoothness of the etching surface can be improved.

Preferably, in this case, the content of TiO₂ in the nonmagnetic material is 30 wt % or less. This can lower the amount of TiO₂ particles left without combining with TiCN in the magnetic head substrate obtained, so as to reduce irregularities on the etching surface, whereby the surface smoothness of the etching surface can become better.

The present invention can provide a magnetic head substrate material, a magnetic head substrate, a head slider, and a method of making a magnetic head substrate, which can improve the surface smoothness of the etching surface and lower the difference in height of the air bearing surface.

### BRIEF DESCRIPTION OF THE DRAWINGS

FIG. 1 is an enlarged perspective view of the head slider in accordance with an embodiment of the present invention;

FIG. 2 is a schematic view of a thin-film magnetic head in a direction perpendicular to the air bearing surface;

FIG. 3 is a perspective view showing the magnetic head substrate in accordance with an embodiment of the present invention; and

FIG. 4 is a schematic sectional view of the head slider taken in a direction perpendicular to the air bearing surface.

### DESCRIPTION OF THE PREFERRED EMBODIMENTS

In the following, preferred embodiments of the present invention will be explained in detail with reference to the accompanying drawings. In the explanation of the drawings, constituents identical or equivalent to each other will be referred to with numerals identical to each other without repeating their overlapping descriptions.

A head slider 11 which will be explained in the following includes a thin-film magnetic head 10 and is mounted to a hard disk drive equipped with a hard disk (recording medium). This hard disk drive causes the thin-film magnetic head 10 to record/reproduce magnetic information onto/from a recording surface of the hard disk rotating at a high speed.

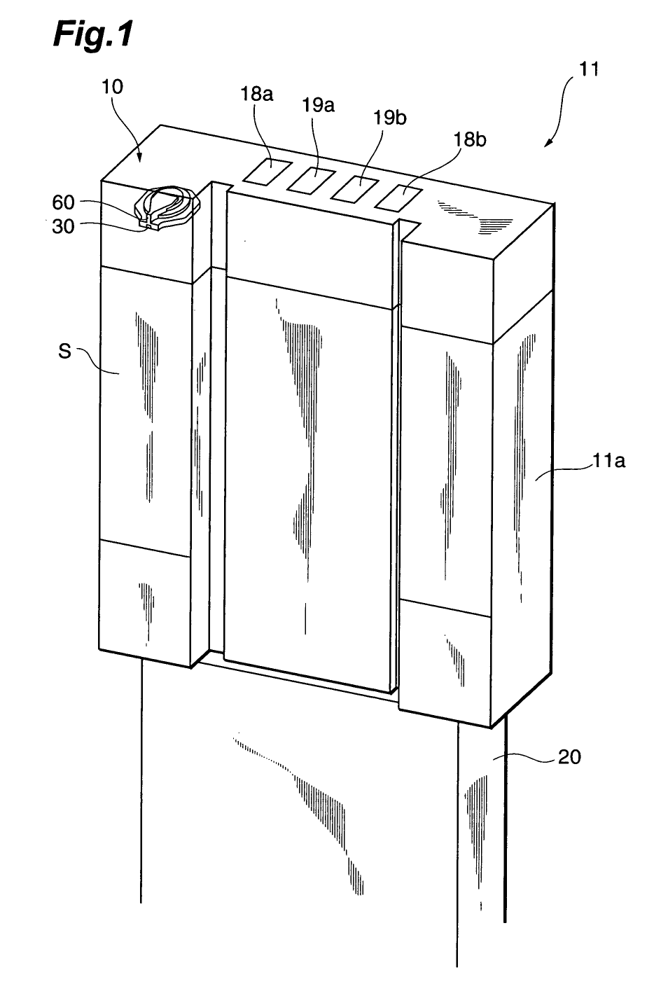

FIG. 1 is an enlarged perspective view of the head slider in accordance with an embodiment of the present invention. The head slider 11 has a substantially rectangular parallelepiped form, in which the thin-film magnetic head 10 is formed on a support 11a. The front-side face in the drawing is a recording medium opposing surface opposing the recording surface of the hard disk, and is referred to as an air bearing surface (ABS) S. When the hard disk rotates, the head slider 11 levitates because of an airflow caused by the rotation, whereby the air bearing surface S is separated from the recording surface of the hard disk. Recording pads 18a, 18b and reproducing pads 19a, 19b are attached on the thin-film magnetic head 10. Such a head slider 11 is mounted on a gimbal 20 and is connected to a suspension arm, which is not depicted, so as to constitute a head gimbal assembly. The air bearing surface S may be provided with a coating of DLC (Diamond Like Carbon) or the like. The thin-film magnetic head 10 has a reproducing head part 30 and a recording head part 60. The reproducing head part 30 and the recording head part 60 are formed in a state buried in the thin-film magnetic head 10 but are illustrated by solid lines in FIG. 1 for the convenience of viewing.

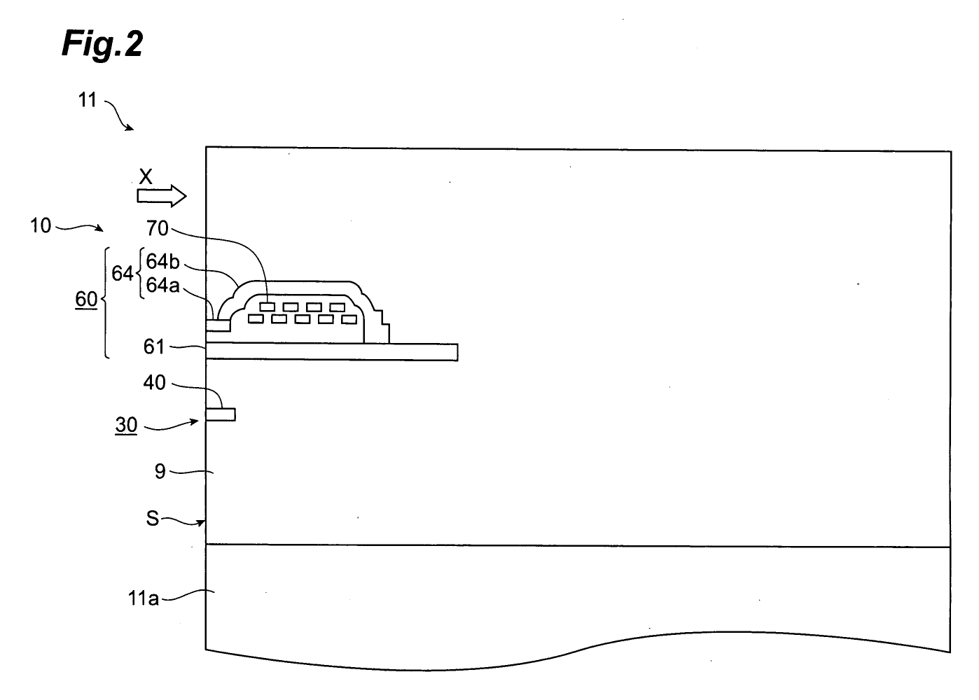

FIG. 2 is a schematic view of the thin-film magnetic head 10 in a direction perpendicular to the air bearing surface S. The thin-film magnetic head 10 has a structure in which a plurality of thin films are laminated on the support 11a, so as to form a composite thin-film magnetic head in which the reproducing head part 30 including a reproducing GMR (Giant MagnetoResistive) device 40, the recording head part 60 as an inductive electromagnetic transducer for writing, and insulator layer 9 which is formed by alumina etc. and encloses the reproducing head part 30 and the recording head part 60 are laminated. The GMR device utilizes a giant magnetoresistive effect yielding a high magnetoresistance change ratio.

The magnetic head part 60 employs a so-called in-plane recording scheme, and mainly comprises a lower magnetic pole (first magnetic pole) 61, an upper magnetic pole (second magnetic pole) 64 which holds the lower magnetic pole 61 between the upper magnetic pole 64 and the GMR device 40 and is magnetically connected to the lower magnetic pole 61, and a thin-film coil 70 partly positioned between the lower magnetic pole 61 and upper magnetic pole 64. The upper magnetic pole 64 is constituted by a magnetic pole part layer 64a positioned on the air bearing surface S side, and a yoke part layer 64b which is connected to the magnetic pole part layer 64a while bypassing the thin-film coil 70 thereunder.

The thin-film magnetic head may employ a perpendicular recording scheme instead of the in-plane recording scheme. The reproducing head part may use an AMR (Anisotropic MagnetoResistive) device utilizing an anisotropic magnetoresistive effect, a TMR (Tunneling MagnetoResistive) device utilizing a magnetoresistive effect occurring at a tunnel junction, or the like in place of the GMR device.

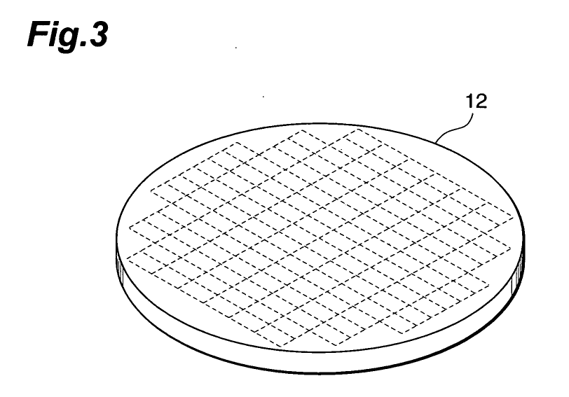

Thus configured head slider 11 is made by the steps of laminating various layers such as the reproducing head part 30 and recording head part 60 on a wafer-shaped magnetic head substrate 12 shown in FIG. 3 by a known technique, and then cutting it into a predetermined form/size as indicated by broken lines in FIG. 3, for example. The support 11a is in a state after cutting the magnetic head substrate 12.

In this embodiment, the magnetic head substrate 12 is made as follows by using a magnetic material containing materials for TiCN or materials for TiCN and TiO₂. Namely, powders of materials for TiCN or materials for TiCN and TiO₂ are pulverized by ball milling under an atmosphere of Ar or the like until the average particle size becomes 1 μm or less, for example, so as to yield a material powder for the magnetic head substrate 12. When making a magnetic head substrate by using TiCON, powders of TiCN and TiO₂ are compounded so as to become respective desirable portions, then are mixed by a ball mill under an atmosphere of Ar or the like, and thereafter are fired at a temperature of 700° C. to 1500° C., so as to produce TiCON. Subsequently, thus obtained product is pulverized again by a ball mill, so as to yield an average particle size of 1 μm or less (e.g., under an Ar atmosphere).

Next, the material powder obtained by the foregoing pulverization is press-molded by a mold having a predetermined size, and the resulting molded article is preliminarily sintered in a nonoxidizing atmosphere such as N₂ (nitrogen), for example. Then, the molded article preliminarily sintered to a certain extent is subjected to HIP (Hot Isostatic Pressing), so as to yield a sintered body whose tissue is densified to the vicinity of its theoretical value. Thereafter, the resulting sintered body is subjected to annealing as necessary, so as to yield the magnetic head substrate 12 shown in FIG. 3. Thus obtained magnetic head substrate 12 yields a hardness lower than that obtained in the case using a magnetic head substrate material containing TiC.

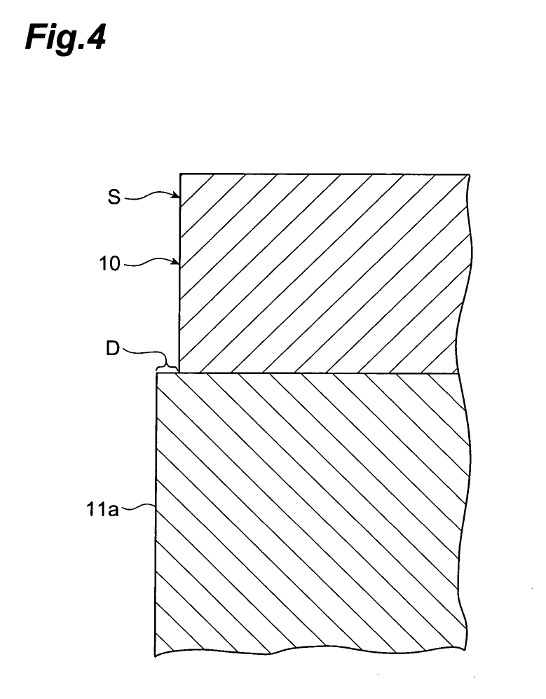

Meanwhile, a head slider is subjected to a lapping step for forming the air bearing surface S in its manufacturing process. In the lapping step, the support and the thin-film magnetic head laminated thereon are polished simultaneously in a direction (direction of arrow X in FIG. 2) intersecting the laminating direction. If the magnetic head substrate is made by using a magnetic head substrate material containing TiC here, the magnetic head substrate will be harder than the thin-film magnetic head, whereby their lapping rates will differ from each other, thus yielding a difference in their amounts of shaving. Then, as shown in FIG. 4, the thin-film magnetic head 10 will be shaven more than the support 11a, so as to yield a difference D in height in the air bearing surface S as shown in FIG. 4. FIG. 4 is a schematic sectional view of the head slider in a direction perpendicular to the air bearing surface S.

By contrast, the magnetic head substrate 12 in accordance with this embodiment yields a hardness lower than that obtained in the case using a magnetic head substrate material containing TiC, so that the amount of shaving of the support 11a, can be made substantially on a par with that of the thin-film magnetic head 10, whereby the difference D in height shown in FIG. 4 can be reduced. Thus, the air bearing surface S can be polished to a substantially flat state.

Since the magnetic head substrate 12 is constituted by substantially a single phase of TiCN or TiCON, irregularities on the etching surface generated by particles of constituent materials floating up are reduced, whereby the surface smoothness of the etching surface is improved.

In the magnetic head substrate material containing TiO₂ together with TiCN, TiO₂ functions as a sintering additive, thereby improving the sintering property. The magnetic head substrate 12 obtained by sintering the magnetic head substrate material is constituted by a sintered body containing TiCN. Thus, the magnetic head substrate material containing O yields a hardness lower than that of the magnetic head substrate constituted by a sintered body containing TiCN.

### EXAMPLES

In the following, the present invention will be explained in further detail in terms of Examples and Comparative Examples with reference to Tables 1 to 5. However, these examples do not restrict the present invention at all.

In these examples, magnetic head substrates comprising different constituent materials were made by the above-mentioned method, and the Vickers hardness (Hv), ion milling property (surface roughness Ra of the etching surface), RIE property (surface roughness Ra of the etching surface), and the difference (D) in height of the air bearing surface of the head slider made by using the magnetic head substrate were measured in each magnetic head substrate.

First, as Comparative Example 1, results of measurement of the above-mentioned values concerning a magnetic head substrate formed by 60 wt % of Al₂O₃ and 40 wt % of TiC, which have conventionally been mainstream, are shown in Table 1.

TABLE 1
COMPARATIVE EXAMPLE 1 [Al₂O₃(60%) + TiC(40%)]

| VICKERS | ION MILLING | RIE | HEIGHT |
|---|---|---|---|
| HARDNESS | PROPERTY | PROPERTY | DIFFERENCE D |
| Hv | Ra(nm) | Ra(nm) | nm |
| 2100 | 1.2 | 1.0 | 6.0 |

Next, as Example 1, results of measurement of the above-mentioned values concerning a magnetic head substrate formed by TiCON and 30 wt % of TiO₂ in accordance with the present invention are shown in Table 2. Table 2 lists results of measurement of the above-mentioned values concerning samples in which the molar composition ratio of each element of CON (C/O/N) in TiCON was varied.

TABLE 2
EXAMPLE 1 [TiCON + TiO₂(30 WT %)

| | | ION | | |
|---|---|---|---|---|
| CON | VICKERS | MILLING | RIE | HEIGHT |
| RATIO | HARDNESS | PROPERTY | PROPERTY | DIFFERENCE D |
| C/O/N | Hv | Ra(nm) | Ra(nm) | nm |
| 0/0/10 | 1000 | 0.5 | 1.0 | 3.0 |
| 1/0/9 | 1200 | 0.5 | 0.4 | 2.0 |
| 2/0/8 | 1250 | 0.5 | 0.3 | 2.0 |
| 3/0/7 | 1500 | 0.5 | 0.2 | 2.0 |
| 5/0/5 | 1650 | 0.6 | 0.3 | 2.0 |
| 7/0/3 | 1900 | 0.6 | 0.3 | 2.0 |
| 1.8/1/7.2 | 1220 | 0.8 | 0.6 | 0.5 |
| 1.4/3/5.6 | 1210 | 0.8 | 0.8 | 0.5 |
| 1/5/4 | 1200 | 0.8 | 1.0 | 0.5 |

As shown in Table 2, it was seen that the Vickers hardness in each of the samples in Example 1 was lower than that of Comparative Example 1. As a result, the height difference D of the air bearing surface in each sample was smaller than that in Comparative Example 1. This is presumed to be because the decrease in Vickers hardness reduced the difference between the amount of shaving (lapping rate) of the magnetic head substrate and the amount of shaving of the thin-film laminate (thin-film magnetic head) on the magnetic head substrate.

It was also seen that the ion milling property in each of the samples in Example 1 was improved (reduced) as compared with that of Comparative Example 1. The RIE property was 1.0 nm in the cases where the C/O/N ratio was 0/0/10 and 1/5/4 as in Comparative Example 1, but was lower than that of Comparative Example 1 at the other C/O/N ratios.

Next, as Example 2, results of measurement of the above-mentioned values concerning a magnetic head substrate formed by TiCON and 10 wt % of Al₂O₃ in accordance with the present invention are shown in Table 3. Table 3 lists results of measurement of the above-mentioned values concerning samples in which the molar composition ratio of each element of CON (C/O/N) in TiCON was varied.

TABLE 3
EXAMPLE 2 [TiCON + Al₂O₃(10 WT %)

| | | ION | | |
|---|---|---|---|---|
| CON | VICKERS | MILLING | RIE | HEIGHT |
| RATIO | HARDNESS | PROPERTY | PROPERTY | DIFFERENCE D |
| C/O/N | Hv | Ra(nm) | Ra(nm) | nm |
| 0/0/10 | 1200 | 0.3 | 1.0 | 6.0 |
| 1/0/9 | 1300 | 0.3 | 0.5 | 2.0 |
| 2/0/8 | 1450 | 0.4 | 0.3 | 2.0 |
| 3/0/7 | 1600 | 0.6 | 0.2 | 2.0 |
| 5/0/5 | 1800 | 0.7 | 0.4 | 2.0 |
| 7/0/3 | 1900 | 1.2 | 1.0 | 5.0 |
| 1.8/1/7.2 | 1800 | 0.7 | 0.6 | 0.5 |
| 1.4/3/5.6 | 1600 | 0.9 | 0.8 | 1.0 |
| 1/5/4 | 1600 | 1.0 | 1.5 | 6.0 |

As shown in Table 3, it was seen that the Vickers hardness in each of the samples in Example 2 was lower than that of Comparative Example 1. As a result, the height difference D of the air bearing surface in each sample was smaller than that in Comparative Example 1 in general. However, the height difference D was 6.0 nm in the cases where the C/O/N ratio was 0/0/10 and 1/5/4 as in Comparative Example 1, and a value (5.0 nm) close to that of Comparative Example 1 when the C/O/N ratio was 7/0/3.

It was seen that the ion milling property was 1.2 nm in the case where the C/O/N ratio was 7/0/3 as in Comparative Example 1, and a value (1.0 nm) close to that of Comparative Example 1 when the C/O/N ratio was 1/5/4. The ion milling property was not greater than 1.0 nm at the other C/O/N ratios.

The RIE property in the case where the C/O/N ratio was 1/5/4 was 1.5 nm, which was greater than that in Comparative Example 1, and was 1.0 nm in the cases where the C/O/N ratio was 0/0/10 and 7/0/3 as in Comparative Example 1. However, the RIE property was not greater than 1.0 nm at the other C/O/N ratios, and thus was seen to be lower than that in Comparative Example 1.

Next, as Comparative Example 2, results of measurement of the above-mentioned values concerning a magnetic head substrate formed by TiCON and 20 wt % of Al₂O₃ are shown in Table 4. Table 4 lists results of measurement of the above-mentioned values concerning TiON whose C/O/N ratio was 1/0/9.

TABLE 4
COMPARATIVE EXAMPLE 2 [TiCON + Al₂O₃(20 WT %)]

| | | ION | | |
|---|---|---|---|---|
| CON | VICKERS | MILLING | RIE | HEIGHT |
| RATIO | HARDNESS | PROPERTY | PROPERTY | DIFFERENCE D |
| C/O/N | Hv | Ra(nm) | Ra(nm) | nm |
| 1/0/9 | 800 | 1.5 | 1.8 | 7.0 |

In Comparative Example 2, as shown in Table 4, the Vickers hardness decreased to about ⅓ that of Comparative Example 1, whereas the height difference D became a value (7.0 nm) greater than that of Comparative Example 1. This is presumed to be because the Vickers hardness decreased so much that the amount of shaving (lapping rate) of the magnetic head substrate exceeded that of the thin-film laminate (thin-film magnetic head) on the magnetic head substrate.

The ion milling property and RIE property were 1.5 nm and 1.8 nm, respectively, both being inferior to those in Comparative Example 1. This is presumed to be because the ratio of Al₂O₃ was so large that Al₂O₃ particles floating up to the etching surface increased, whereby a greater number of irregularities were formed on the etching surface.

Next, as Comparative Example 3, results of measurement of the above-mentioned values concerning a magnetic head substrate formed by TiCON and 15 wt % of Al₂O₃ are shown in Table 5. Table 5 lists results of measurement of the above-mentioned values concerning TiON whose C/O/N ratio was 1/0/9.

TABLE 5
COMPARATIVE EXAMPLE 3 [TiCON + Al₂O₃(15 WT %)]

| | | ION | | |
|---|---|---|---|---|
| CON | VICKERS | MILLING | RIE | HEIGHT |
| RATIO | HARDNESS | PROPERTY | PROPERTY | DIFFERENCE D |
| C/O/N | Hv | Ra(nm) | Ra(nm) | nm |
| 1/0/9 | 950 | 1.4 | 1.3 | 5.0 |

In Comparative Example 3, as shown in Table 5, the Vickers hardness was 950, which was less than half that of Comparative Example 1, whereas the height difference D was 5.0. This is presumed to be because the substrate failed to yield such a Vickers hardness as to sufficiently reduce the difference between the amount of shaving of the magnetic head substrate and that of the thin-film laminate (thin-film magnetic head) on the magnetic head substrate.

The ion milling property and RIE property were 1.5 nm and 1.8 nm, respectively, both being inferior to those in Comparative Example 1. This is presumed to be because the ratio of Al₂O₃ in Comparative Example 3 was lower than that in Comparative Example 2 but not so sufficiently low, whereby a large number of Al₂O₃ particles still float up to the etching surface.

As in the foregoing, it has been seen that the magnetic head substrate in accordance with the present invention improves the ion milling property and RIE property, and the height difference D of the air bearing surface of the head slider made by using the magnetic head substrate over the magnetic head substrate formed by Al₂O₃ (60 wt %) and TiC (40 wt %), which has conventionally been mainstream. It has also been verified that all of the ion milling property, RIE property, and height difference D improve with a favorable balance when the composition ratio of N is 50% to 90%.

In the above-mentioned Tables 2 to 6, samples whose O composition ratio is 0 refer to those in which the O composition ratio is less than 1%. From the ball mill used in the material pulverizing/mixing step, 1 wt % or less of Al₂O₃ mingled into both of Examples 1 and 2.

1. A magnetic head substrate material comprising a nonmagnetic material, substantially free of Al₂O₃, containing TiCN.

2. A magnetic head substrate material comprising a nonmagnetic material, substantially free of Al₂O₃, containing TiCN and TiO₂.

3. The magnetic head substrate material according to claim 2, wherein the content of TiO₂ in the nonmagnetic material is 30 wt % or less.

4. A magnetic head substrate comprising a sintered body, substantially free of Al₂O₃, containing TiCN.

5. The magnetic head substrate according to claim 4, wherein x/(x+y) is at least 50% but not greater than 90%, where the molar composition of TiCN is expressed as TiC_{y}Nₓ.

6. The magnetic head substrate according to claim 4, wherein the sintered body contains TiO₂ by a content of 30 wt % or less.

7. A magnetic head substrate comprising a sintered body, substantially free of Al₂O₃, containing TiCON.

8. The magnetic head substrate according to claim 7, wherein wherein x/(x+y+z) is at least 50% but not greater than 90%, where the molar composition of TiCON is expressed as TiC_{y}O_{z}Nₓ.

9. The magnetic head substrate according to claim 7, wherein the sintered body contains TiO₂ by a content of 30 wt % or less.

10. A magnetic head substrate comprising a sintered body containing TiCN and Al₂O₃, wherein the content of Al₂O₃ is 10 wt % or less.

11. The magnetic head substrate according to claim 10, wherein the content of Al₂O₃ is at least 2 wt %.

12. A magnetic head substrate comprising a sintered body containing TiCON and Al₂O₃, wherein the content of Al₂O₃ is 10 wt % or less.

13. The magnetic head substrate according to claim 12, wherein the content of Al₂O₃ is at least 2 wt %.

14. A head slider comprising:
a support constituted by a sintered body, substantially free of Al₂O₃, containing TiCN; and
a thin-film magnetic head, formed on the support, for recording and/or reproducing with respect to a recording medium.

15. The head slider according to claim 14, wherein the support contains TiO₂ by a content of 30 wt % or less.

16. A head slider comprising:
a support constituted by a sintered body, substantially free of Al₂O₃, containing TiCON; and
a thin-film magnetic head, formed on the support, for recording and/or reproducing on/from a recording medium.

17. The head slider according to claim 16, wherein the support contains TiO₂ by a content of 30 wt % or less.

18. A head slider comprising:
a support constituted by a sintered body containing TiCN and Al₂O₃, the content of Al₂O₃ being 10 wt % or less; and
a thin-film magnetic head, formed on the support, for recording and/or reproducing with respect to a recording medium.

19. The head slider according to claim 18, wherein the content of Al₂O₃ is at least 2 wt %.

20. A head slider comprising:
a support constituted by a sintered body containing TiCON and Al₂O₃, the content of Al₂O₃ being 10 wt % or less; and
a thin-film magnetic head, formed on the support, for recording and/or reproducing with respect to a recording medium.

21. The head slider according to claim 20, wherein the content of Al₂O₃ is at least 2 wt %.

22. A method of making a magnetic head substrate, the method comprising the steps of:
preparing a nonmagnetic material, substantially free of Al₂O₃, containing TiCN; and
sintering the nonmagnetic material.

23. A method of making a magnetic head substrate, the method comprising the steps of:
preparing a nonmagnetic material, substantially free of Al₂O₃, containing TiCN and TiO₂; and
sintering the nonmagnetic material.

24. The method of making a magnetic head substrate according to claim 23, wherein the content of TiO₂ in the nonmagnetic material is 30 wt % or less.
